(19) United States
(12) Patent Application Publication
(10) Pub. No.: US 2012/0254853 A1
(43) Pub. Date: Oct. 4, 2012

(54) CUSTOMIZING MOBILE APPLICATIONS

(75) Inventors: Vikram Aggarwal, Mountain View, CA (US); Jiten Vaidya, San Jose, CA (US)

(73) Assignee: GOOGLE INC., Mountain View, CA (US)

(21) Appl. No.: 13/249,899

(22) Filed: Sep. 30, 2011

Related U.S. Application Data
(63) Continuation of application No. 13/077,599, filed on Mar. 31, 2011.

(51) Int. Cl. G06F 9/44; G06F 21/20; G06F 15/16; H04L 9/32

(52) U.S. Cl. 717/173; 717/168; 726/7

(57) ABSTRACT

In general, this disclosure describes techniques for generating customized versions of mobile applications for computing devices according to user's preferences and/or device information for downloading onto a user's computing device. A web application executing on a first computing device (e.g., back end system or server) associated with the service provider associated with the mobile application may receive user information specifying one or more preferences associated with the mobile application. A compiler of the first computing device may generate a user-specific version of the mobile application based on the received user information. The generated user-specific version of the mobile application may then be communicated to a mobile computing device that is capable of executing the mobile application.

This application is a Continuation of U.S. application Ser. No. 13/077,599, filed Mar. 31, 2011, the entire contents of which is hereby incorporated by reference.

### TECHNICAL FIELD

This disclosure relates to generating application for computing devices, such as mobile computing devices.

### BACKGROUND

Users of computing devices often acquire applications for their computing devices (e.g., mobile phones). A user may acquire the applications by downloading applications from an application store or from the associated service (e.g., financial institution). The user may download an application using the computing device or by connecting to another computing device (e.g., desktop computer). Mobile applications are often provided by a third party. Additionally, mobile applications often target providing all sorts of information to the user, and frequently include more information than a user may want to access using the application.

### SUMMARY

In general, this disclosure describes techniques for providing a user of a computing device with the ability to acquire customized applications for the user and/or computing device, e.g., mobile device. The user may provide his/her customization preferences of an application (e.g., mobile banking application) to the provider of the application (e.g., financial institution). The techniques allow processing of the preferences and generation of a version of the application that is user- and/or device-specific based on the preferences. The user- and/or device-specific version of the application may then be downloaded to the user's computing device.

In one example, the disclosure is directed to a method comprising receiving, by a web application executing on a first computing device, user information that specifies one or more preferences associated with a mobile application that is to be generated by the first computing device, generating, by a compiler of the first computing device, a user-specific version of the mobile application based on the user information, and communicating the generated user-specific version of the mobile application to a mobile computing device that is capable of executing the mobile application.

In another example, the disclosure is directed to a computer-readable storage medium encoded with instructions that, when executed, cause one or more processors at a first computing device to perform operations comprising receiving, by a web application executing on the first computing device, user information that specifies one or more preferences associated with a mobile application that is to be generated by the first computing device, generating, by a compiler of the first computing device, a user-specific version of the mobile application based on the user information, and communicating the generated user-specific version of the mobile application to a mobile computing device that is capable of executing the mobile application.

In another example, the disclosure is directed to a computing device comprising one or more processors, a module operable by the one or more processors to receive, by a web application executing on the first computing device, user information that specifies one or more preferences associated with a mobile application that is to be generated by the first computing device, means for generating a user-specific version of the mobile application based on the user information, and a module operable by the one or more processors to communicate the generated user-specific version of the mobile application to a mobile computing device that is capable of executing the mobile application.

The techniques of this disclosure may provide one or more advantages. For example, certain techniques may allow a user of a computing device to acquire a version of an application specifically generated based on user preferences, which may differ from preferences of other users of the same application. Additionally, the techniques of this disclosure provide a more secure version of mobile applications to users, especially, for applications that may involve sensitive information, e.g., applications associated with financial services. Furthermore, techniques of this disclosure allow the service providers supplying the application to increase the authenticity of the applications and specifying it to a user such that redistribution of an application is not easy, as only the user authorized to utilize the application is able to use it.

The details of one or more embodiments of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram illustrating an example system in accordance with techniques of this disclosure.

FIG. 2A is a block diagram illustrating further details of one example of the computing device shown in FIG. 1.

FIG. 2B is a block diagram illustrating details of one example of the application development system shown in FIG. 1.

FIG. 3 is a flow diagram illustrating a method that may be performed by one or more computing device in accordance with the techniques of the present disclosure.

### DETAILED DESCRIPTION

In general, this disclosure describes techniques for generating customized versions of applications for computing devices according to user's preferences and/or device information for downloading onto a user's computing device. As one example, a user may request an application, customized according to his/her preferences, from a service provider associated with the application. The service provider may generate a version of the application that is customized based on the preferences indicated by the user and/or information about the user's device. The user may then install or download the generated customized version of the application on his/her computing device.

As computing devices, especially mobile computing devices, become more widely used, users become more dependent on their computing devices for a wide range of activities. As mobile computing devices become more sophisticated, users expect to be able to access all types of information on-the-go. As a result, applications associated with different services are becoming more wide-spread and popular. Users of mobile computing device, therefore, expect to be able to have applications for nearly any service. In creating applications for all types of services on mobile computing devices, service providers often provide all users with the same application, which usually covers all services provided by the provider. As a result, the applications often lack customization, and for certain types of applications, users may desire to limit the functionality of an application on a mobile computing device to specific aspects that may differ from one user to another.

At the same time, users do not want to compromise the security of their personal information, which is an issue with such services as financial institutions, for example. As applications for mobile computing devices become more popular, many sources are creating applications, but sometimes these sources are not authorized by the service providers to offer the applications. Therefore, a user may not be able to determine whether the source of the application is a trusted one, or be able to authenticate the source of the application. As a result, lack of trust may become an issue, as users are often unable to authenticate the source of the application when these users download applications to their mobile computing devices.

In addition to the customization and trust issues with applications, when sources other than the service providers develop applications, the applications may lack watermarking information. As a result, problems with unauthorized distribution of applications are becoming more common, where users distribute applications installed on their computing devices without consequences.

Developers of applications, especially for mobile devices, currently utilize source code that produces a version of the application that is not necessarily user-dependent. A compiler may be capable of compiling the source code to produce a version of the mobile application that is user-independent, in that any user with a mobile device may acquire a version of the mobile application. Multiple users may acquire the generated mobile application, which appears the same to all users. Therefore, customization options are limited or nonexistent, and any entity other than the service providers associated with the application may be capable of producing an application for any services, sometimes, an unreliable or an insecure application.

Techniques of this disclosure allow the service providers to generate application executables to users, such that the applications are customizable for each specific user and/or user device. The infrastructure of the system may provide the ability to inject user-specific and/or device information into the application before an application executable is generated. In this manner, several users downloading the same application, in reality, each downloads a version of the application that is specific to each user and/or user's device.

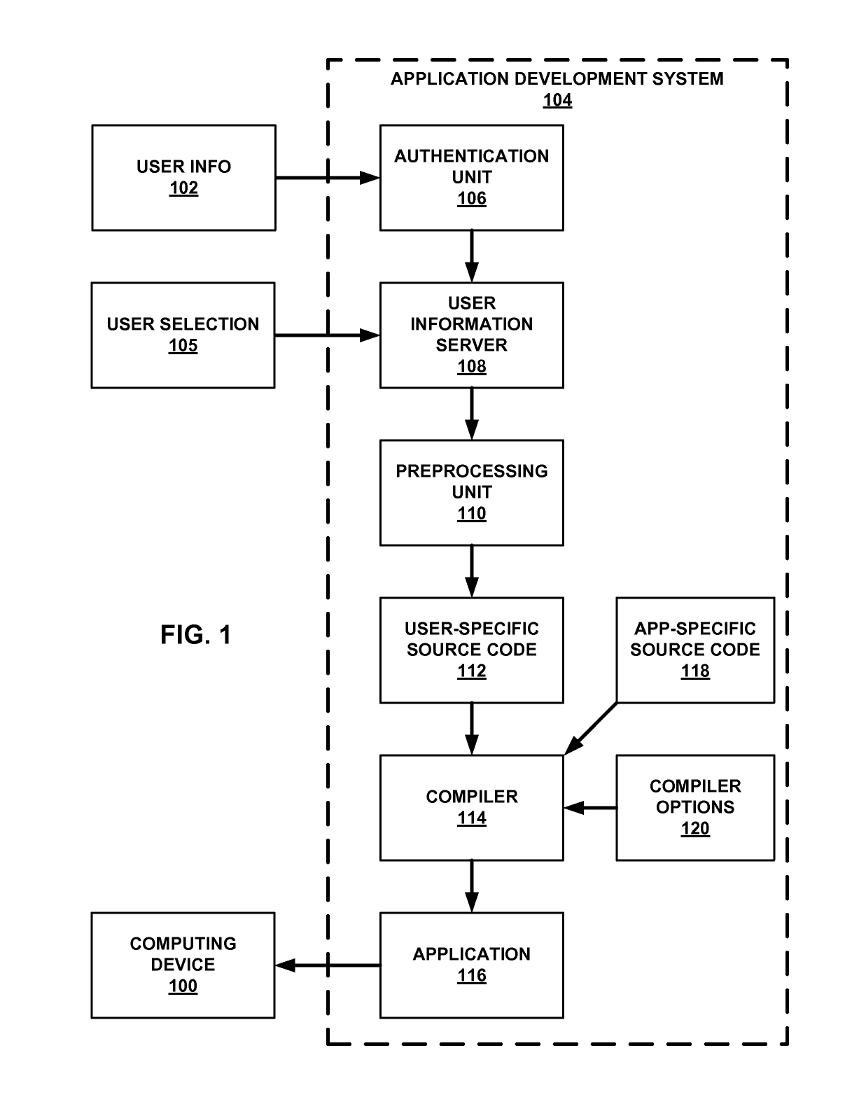

FIG. 1 is a block diagram illustrating an example system in accordance with techniques of this disclosure. In the example of FIG. 1, the system may include an application development system 104 and computing device 100. Application development system 104 may be part of an infrastructure associated with an application provider, which may be a service provider (e.g., financial institution) or an application supplier (e.g., a browser developer), for example. Computing device 100 may be equipped to download and execute applications associated with application development system 104. Computing device 100 may be a mobile device such as, for example, a mobile phone, tablet computer, personal digital assistant (PDA), or the like.

In one example, the user's computing device 100 may be a mobile phone with a mobile application for a service (e.g., a banking service, a browser) that the user utilizes. The user may wish to acquire a customized and secure version of the mobile application that better fits the user's preferences. For example, in the banking service example, the user may wish to acquire a customized banking application that shows a selection of the user's accounts and/or allows the user to perform a selection of tasks (e.g., check balance, transfer a maximum of $500 between accounts, and the like). Therefore, the user may wish to have a limited

In the example of FIG. 1, a user may provide user information 102, which may be, for example, login information or any other user-authentication information. User information 102 may be specific to the user and the service provider for which the user wishes to acquire a customized application. In the example of a financial institution, user information 102 may comprise an account number or a user name and a password or pass code associated with the user. The user may provide user information 102 through the service provider, for example, by visiting a website associated with the service provider.

The service provider may utilize application development system 104 for developing applications specific for the service provider that users may download onto computing devices. Application development system 104 may include capabilities such as, for example, authentication unit 106, user information server 108, preprocessing unit 110, user specific source 112, compiler 114, application 116, application-specific source code 118, and compiler options 120, which will be described in more detail below.

As the user provides user information 102, application development system 104 may utilize authentication unit 106 to authenticate the user as a user registered with the service provider. In the example of the financial institution, authentication unit 106 may determine whether the user, based on user information 102, has an account with the financial institution or has the authority to manage the account. Upon authentication of the user by authentication functionality 106, user information may be retrieved from user information server 108. The user information retrieved from user information server 108 may vary from one user to another. In one example, the user may also provide additional input, once authentication is completed, where the additional input may specify user selection 105. User selection 105 may include user-specific customizations defining settings that the user wishes to have in the generated application. In the example of the financial institution, the user may select which of the banking and financial services available to the user he/she wishes to be able to access using the application for the computing device. For example, the user may wish to only access the balances of his/her accounts with the financial institution, but not be able to make transfers, or only perform certain transfers, or limit the amount of money that can be transferred using the application.

Preprocessing unit 110 may then process the retrieved user-specific information to produce user-specific source code 112. A preprocessor typically processes input data to produce data that is used as input to another program. In this example, the input to preprocessing unit 110 may include source code that contributes to the final application generated by application development system 104 and user preferences as specified by the different user inputs. In one example, preprocessing unit 110 may select a subset of the source code associated with the application based on user preferences. For example, if the user preferences for an application associated with a financial institution indicate the user does not wish to show information about user's savings account, the portion of the application source code associated with savings account may not be selected for further processing.

Preprocessing unit 110 may produce user-specific source code 112, which includes source modules associated with the application that will generate the customized or user-specific application. In the example of the application associated with a financial institution, some source modules may be modules that allow the user to read account balance, transfer money between accounts, and user preferences may specify what can and cannot be done (e.g., can read information about accounts, cannot change information, and the like). Preprocessor unit 110 may then, when producing the user-specific source code 112, only include the source module that allows reading account balances, but not the module that allows transferring money between accounts.

Compiler 114 utilizes user-specific source code 112 to produce application 116, which may vary depending on the user. During compiling, compiler 114 may also utilize other source code associated with the application, for portions of the application that are not user-specific such as, for example, graphics and logos. For example, compiler 114 may utilize application-specific source code 118, which may be associated with the application the user wants to acquire. Therefore, application-specific source code 118 may vary depending on the application and the application provider. For example, one financial institution's application-specific source code may be different from another financial institution's application-specific source code. Additionally, if one application provider is associated with several services, application-specific source code 118 may vary based on the service.

In one example, application-specific source code 118 may include information used for performing actions specific to the domain associated with the application. That is, application-specific source code 118 may be used to define actions and operations, which may be executed during run-time, e.g., when the application is selected by the user on computing device 100. In one example, at least some of user-specific source code 112 may be used by the compiler during build time to generate user-specific application 116, such that, the user-specific information is built into the generated application, instead of being executed during run-time.

Compiler 114 may also utilize compiler options 120, which may vary depending on the type of compiler used. In one example, as FIG. 1 illustrates, compiler 114 may receive multiple input such as different source codes and options. The source code may be files corresponding to the platform of the application. For example, the generated application may be a java application, and the source code may be java program files, which when compiled, generate a java application. Compiler 114 may be a program that transforms the input source code and other options into an executable program or file, e.g., application 116. The type of compiler used may depend on the type of application being generated. For example, application 116 may be a java application, and compiler 114 may be a compiler capable of translating source code and files into a java executable file, e.g., OpenJDK java compiler.

The user may then acquire the generated user-specific application 116 on user's computing device 100 (e.g., mobile computing device). In one example, the user may acquire application 116 by downloading the generated application directly from the service provider, from another computing device (e.g., a personal computer), or from user's computing device 100.

In another example, the user-specific version of the application may be generated and encoded as a computer-readable image, e.g., QR code or bar code. In this example, user's computing device 100 may have an image capture device (e.g., camera) that computing device 100 can utilize to scan the computer-readable image. User's computing device 100 may also have a reader application, which may decode the scanned image to obtain the generated user-specific application 116. In one example, the computer-readable image may encode the compiled user-specific application 116, and decoding the image results in directly placing the user-specific application on computing device 100. In another example, the computer-readable image may encode a universal resource locator (URL), and decoding the image results in launching a browser application and redirecting to the encoded URL, resulting in downloading the user-specific application 116.

Once the user has acquired the user-specific version of the application, the user may be able to utilize the application by launching it on the computing device. When the application is running on user's computing device, the user may be able to interact with features of the application that he or she selected in user's preferences. Therefore, in one example, the user sees a version of the application on user's computing device according to the preferences of the user, which may differ from what another user sees on another computing device. Additionally, by acquiring the application directly from the associated service provider, the authenticity of the application is trusted and the user may be more confident in the safety of using the application, especially in the example of applications that deal with sensitive information (e.g., financial data). These are some example advantages of the techniques of this disclosure. Additional advantages may be associated with the techniques described here, as will be evident from the discussion herein.

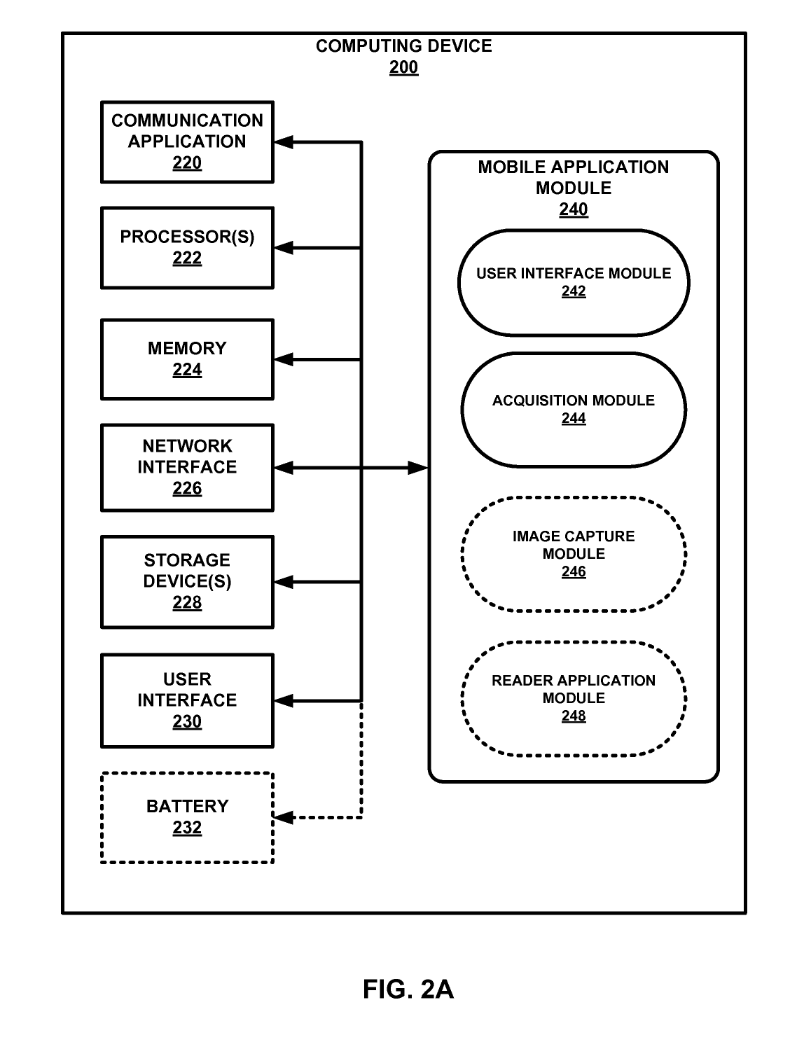

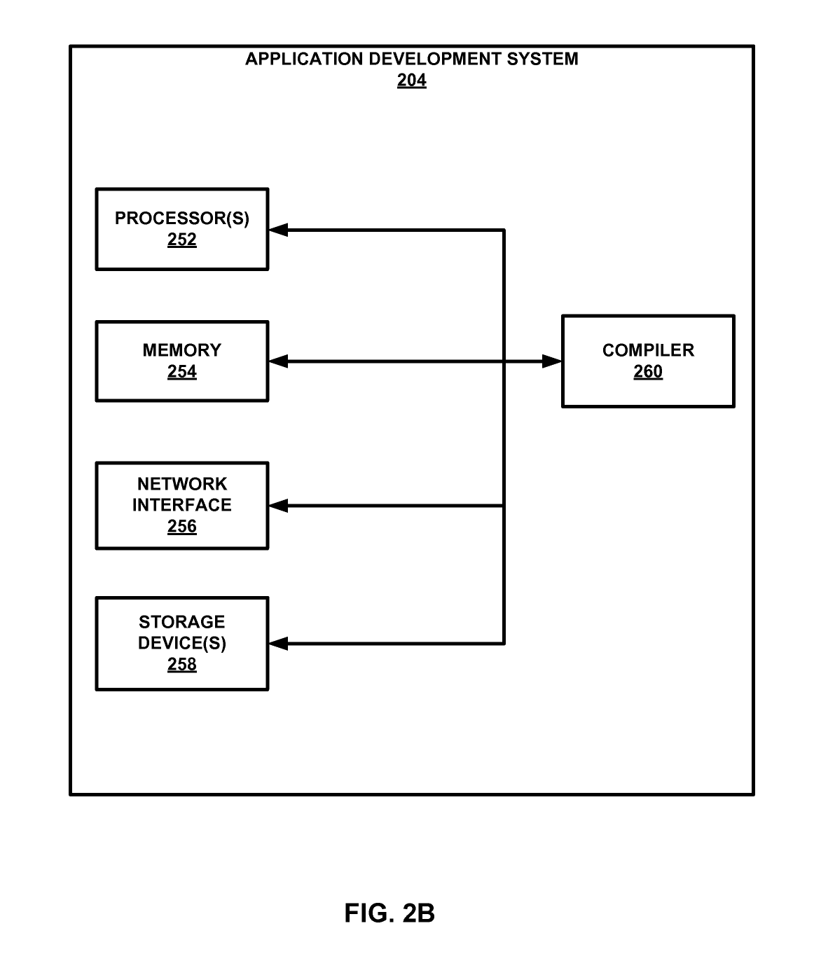

FIG. 2A is a block diagram illustrating further details of one example of computing device 100 shown in FIG. 1. FIG. 2A illustrates only one particular example of computing device 200, and many other example embodiments of computing device 100/200 may be used in other instances. As noted above, in one example, the user may utilize computing device 100/200 to access application development system 104 and cause the generation of user-specific application 116, which may be then acquired by computing device 100/200. In another example, the user may utilize a separate computing device to access application development system 104 and cause the generation of user-specific application 116, which may then be acquired by computing device 100/200. While the example of FIG. 2A illustrates the former, it should be understood that the same techniques may be similarly achieved in the latter example.

As shown in the example of FIG. 2A, computing device 200 includes communication application 220, one or more processors 222, memory 224, a network interface 226, one or more storage devices 228, user interface 230, and an optional battery 232. For example, if computing device 200 comprises a mobile or portable device, computing device 200 may include battery 232. Each of components 220, 222, 224, 226, 228, 230, and 232 may be interconnected via one or more busses for inter-component communications. Processors 222 may be configured to implement functionality and/or process instructions for execution within computing device 200. Processors 222 may be capable of processing instructions stored in memory 224 or instructions stored on storage devices 228.

User interface 230 may include, for example, a monitor or other display device for presentation of visual information to a user of computing device 200. User interface 230 may further include one or more input devices to enable a user to input data, such as a manual keyboard, mouse, touchpad, track pad, etc. In some examples, user interface 230 may comprise a touch screen, which may be used both to receive and process user input and also to display output information and application-specific options. User interface 230 may further include printers or other devices to output information. In various instances in the description contained herein, references made to user interface 230 may refer to portions of user interface 230 (e.g., keyboard, touch screen, mouse device) that provide user input functionality.

Memory 224 may be configured to store information within computing device 200 during operation. Memory 224 may, in some examples, be described as a computer-readable storage medium. In some examples, memory 224 is a temporary memory, meaning that a primary purpose of memory 224 is not long-term storage. Memory 224 may also be described as a volatile memory, meaning that memory 224 does not maintain stored contents when the computer is turned off. Examples of volatile memories include random access memories (RAM), dynamic random access memories (DRAM), static random access memories (SRAM), and other forms of volatile memories known in the art. In some examples, memory 224 may be used to store program instructions for execution by processors 222. Memory 224 may be used by software or applications running on computing device 200 (e.g., reader application) to temporarily store information during program execution.

Storage devices 228 may also include one or more computer-readable storage media. Storage devices 228 may be configured to store larger amounts of information than memory 224. Storage devices 228 may further be configured for long-term storage of information. In some examples, storage devices 228 may comprise non-volatile storage elements. Examples of such non-volatile storage elements may include magnetic hard discs, optical discs, floppy discs, flash memories, or forms of electrically programmable memories (EPROM) or electrically erasable and programmable (EEPROM) memories.

Computing device 200 also includes network interface 226. Computing device 200 may utilize network interface 226 to communicate with external devices (e.g., one or more servers, web servers, application development system 104) via one or more networks (e.g., wired networks, wireless networks). The network interface 226 allows computing device 200 to connect to one or more networks.

Computing device 200 also includes communication applications 220, which may include applications available on computing device 200 that a user of computing device 200 may utilize for communicating. Communication applications 220 may include, for example, voice- and/or text-based application, such as short message service (SMS) messaging, e-mail, telephone capabilities, and the like.

Any applications or modules implemented within or executed by computing device 200 may be implemented or contained within, operable by, executed by, and/or be operatively coupled to processors 222, memory 224, network interface 226, storage devices 228, and/or user interface 230. One example of such applications or modules may be mobile application module 240. In one example, mobile application module 240 may be operable by processors 222 to acquire a mobile application associated with a service provider or application supplier, as discussed above. Mobile application module 240 may allow the user to indicate an application that the user wishes to acquire for user's computing device 200. Therefore, mobile application module 240 may be utilized to acquire any application and is not associated with one specific application.

Mobile application module 240 may include a user interface module 242 and an acquisition module 244. In some examples, mobile application module 240 may also include an image capture module 246 and a reader application module 248. Mobile application module 240 may be stored in memory 224 and/or storage devices 230, and may be operable by processors 222 to perform various tasks during execution.

When the user of computing device 200 requests to acquire an application (e.g., banking application, web browser), the request results in launching mobile application module 240. User interface module 242 may launch an application (e.g., web browser) that allows the user to interact with the application provider associated with the requested application. User interface module 242 may allow the user to interact with application development system 104 (FIG. 1) as described above. For example, user interface module 242 allows the user to provide user input 102 and user selection 105.

After application development system 104 generates the user-specific application as described above, the user may acquire the generated user-specific application on computing device 200. In one example, an executable version of the user-specific application may be generated and provided to the user as a link or URL, which the user may be able to click on when using computing device 200 to access the application development system, such as using a web browser on computing device 200, for example. Acquisition module 244 of mobile application module 240 may acquire the user-specific application by downloading the generated user-specific application executable and executing it to obtain the application.

In another example, the user may utilize another computing device (e.g., a desktop computer) to access the application development system. In one example, an executable version of the generated user-specific application may be transferred to computing device 200 over a communication link though communication application 220. For example, the executable may be transferred to computing device 200 via e-mail or SMS message. The executable itself may be communicated as an executable file or a link to URL from which the user may download the executable.

In another example, the user-specific version of the application may be generated and encoded as a computer-readable image, e.g., QR code. In this example, image capture module 246 may scan in and read the computer-readable image. Reader application module 248 may be launched when the computer-readable image is scanned and decode the scanned image to obtain the generated user-specific application. In one example, the computer-readable image may encode the compiled user-specific application or the executable, and decoding the image results in executing it and placing the user-specific application on computing device 200 by acquisition module 244. In another example, the computer-readable image may encode a URL, and decoding the image results in launching a browser application and redirecting to the encoded URL, resulting in downloading the user-specific application.

In one example, during implementation or execution of mobile application module 240, user interface module 242 may be operable by processors 222 to display information to the user and to allow the user to input the requested information by displaying a character-entry application (e.g., keyboard or key pad), for example. Acquisition module 244 may be also operable by processors 222 to acquire executable code and execute it properly to obtain the corresponding application. Image capture module 246 may be operable by processors 222 to scan in and read a computer-readable image. Reader application module 248 may be launched by processors 222 when image capture module 246 reads a computer-readable image. Reader application module 248 may be operable by processor 222 to decode a scanned computer-readable image and act according to the information encoded in the computer-generated image, e.g., downloading a file. Reader application module 248 may decode the computer-readable image to determine the information contained therein, e.g., download a generated user-specific application, and send the information to the appropriate module (e.g., acquisition module) for further processing.

In one example, the user-specific version of the application may be provided and stored to user's computing device as a configuration file. During installation of the associated application, mobile application module 240 may read the configuration file and utilize it to modify the version of the application installed on the computing device to the user-specific version.

FIG. 2B is a block diagram illustrating details of one example of the application development system 104 shown in FIG. 1. FIG. 2B illustrates only one particular example of application development system 204, and many other example embodiments of application development system 104/204 may be used in other instances. Application development system 204 may reside entirely in one device (e.g., a back end system or server associated with the service provider who provides the application) or may be distributed among two or more devices (e.g., one or more back end systems or servers associated with the service provider or one or more computing devices). For example, one portion of application development system 204 may be implemented by one server and another portion of application development system 204 may be implemented by another server. In the example of a financial institution, a portion of user information may be on a server that is different from a server that stores source code for the application, for example.

As shown in the example of FIG. 2B, application development system 204 includes one or more processors 252, memory 254, network interface 256, one or more storage devices 258, and compiler 260. In one example, each of components 252, 254, 256, 258, and 260 may be interconnected via one or more busses for inter-component communications. In another example, where components, 252, 254, 256, 258, and 260 reside on two or more device (e.g., back end systems or servers), the components may be interconnected via one or more busses and communication links for inter-component communications, where components at each device may process data and information and transfer it to other devices in application development system 204 via network interface 256 at each of the devices within application development system 204.

Processors 252 may be configured to implement functionality and/or process instructions for execution within application development system 204. Processors 252 may be capable of processing instructions stored in memory 254 or instructions stored on storage devices 258.

Memory 254 may be configured to store information within application development system 204 during operation, for example, during compiling a user-specific version of an application. Memory 254 may, in some examples, be described as a computer-readable storage medium. In some examples, memory 254 is a temporary memory, meaning that a primary purpose of memory 254 is not long-term storage. Memory 254 may also be described as a volatile memory, meaning that memory 254 does not maintain stored contents when the computer is turned off. Examples of volatile memories include random access memories (RAM), dynamic random access memories (DRAM), static random access memories (SRAM), and other forms of volatile memories known in the art. In some examples, memory 254 may be used to store program instructions for execution by processors 252. Memory 254 may be used by software or applications running on application development system 204 (e.g., compiler 260) to temporarily store information during program execution. In one example, memory 254 may store temporary information used by programs executed by processor 252 (e.g., user-specific source code 112 of FIG. 1).

Storage devices 258 may also include one or more computer-readable storage media. Storage devices 258 may be configured to store larger amounts of information than memory 254. Storage devices 258 may further be configured for long-term storage of information. In some examples, storage devices 258 may comprise non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In one example, storage device 258 may store such information as, user information (e.g., information on user information server 108 of FIG. 1), and non-temporary source code and other data (e.g., application-specific source code 118 and compiler options 120 of FIG. 1).

Application development system 204 also includes network interface 256. Application development system 204 may utilize network interface 256 to communicate with external devices (e.g., other servers, web servers, or computing devices 100) via one or more networks (e.g., wired networks, wireless networks). Network interface 256 allows Application development system 204 to connect to one or more networks.

In one example, user information (e.g., user information 102 of FIG. 1) may be transferred to application development system 204 over a network link and received via network interface 256. Processor 252 may then execute an authentication algorithm to determine whether the user, based on the received use information, is registered with the service provider associated with the application. If authenticated, processors 252 may retrieve user information from storage 258 (e.g., user information server). The user may also provide additional information (e.g., user selection 105 of FIG. 1) that is received via network interface 256. As noted above, the additional information may include user-specific customizations defining settings that the user wishes to have in the generated application. During processing, the additional information may be stored in memory 254.

Processor 252 may utilize the user information and the additional information to execute a preprocessing algorithm to obtain user-specific source code. Processors 252 may also retrieve and send application-specific source code and compiler options along with the user-specific source code to compiler 260. Compiler 260 may be similar to compiler 114 of FIG. 1, and may utilize the received information to generate a version of the application according to specific selections by the user to generate a user-specific version of the application. Processors 252 may then transfer the generated user-specific version of the application to the user via network interface 256, as described above.

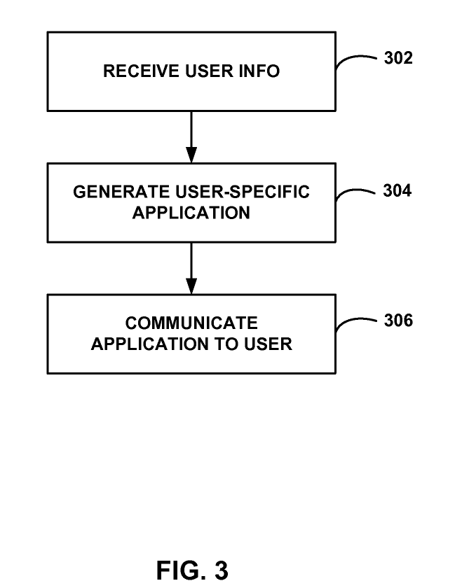

FIG. 3 is a flow diagram illustrating a method that may be performed by one or more computing device in accordance with one or more techniques of the present disclosure. For example, the illustrated example method may be performed by the system of FIG. 1 with respect to computing device 200 of FIG. 2A and application development system 204 of FIG. 2B. In some examples, a computer-readable storage medium associated with application development system 104 (e.g., a memory associated with the server on which application development system 104 resides, memory 254 or storage devices 258 of FIG. 2B) and/or computing device 200 (e.g., storage device 228 of FIG. 2A) may be encoded with instructions that, when executed, cause one or more processors (e.g., processors 222 and/or processors 252) to perform one or more of the acts illustrated in the method of FIG. 3.

The method of FIG. 3 includes receiving, by a web application executing on a first computing device, user information (302). The first computing device may be a back end system or server associated with a service provider, e.g., application development system 104 of FIG. 1. The user information may specify one or more preferences associated with a mobile application that is to be generated by the first computing device. The user may be authenticated based on the received user information. The authentication may indicate that the user is capable of accessing information from the service provider, e.g., financial information of the user from a financial institution. Additionally, authentication also further allows the user to provide user information specifying one or more preferences associated with a mobile application that the user wishes the service provider to generate.

The method further includes generating, by a compiler associated with the first computing device, a user-specific version of the mobile application based on the user information (304). The compiler may acquire and utilize information from a database associated with the first computing device, e.g., a server of users associated with the service provider, to generate the user-specific version of the mobile application. The method also includes communicating the generated user-specific version of the mobile application to a mobile computing device (e.g., computing device 100/200) associated with the user, where the second computing device may be capable of executing the mobile application (306). As described above, the first computing device may communicate the generated user-specific version of the mobile application in one of many several ways. For example, the first computing device may provide a link (e.g., URL) from which the mobile application may be downloaded. In another example, the mobile application may be encoded and sent to the second computing device, which may be capable of decoding the encoded version of the mobile application (e.g., computer-readable image).

The following are some examples that illustrate systems or services where techniques of this disclosure may be implemented. In one example, as mentioned above, a user may wish to use a financial institution's mobile application. Currently, the user may download the application from the market (e.g., an application store accessible by user's computing device), where anyone could have uploaded the application. Even with thorough checks (as with closed mobile application stores), developers may sneak in malware. Instead of downloading the application from the market, techniques of this disclosure allow the financial institution to generate a mobile application specifically tailored for the user, as described above. For example, the user may log into his/her financial institution's website through a computer (e.g., a mobile device), using an existing account. After authenticating, the user may be given an option to download a mobile application specifically tailored for the user.

In one example, the user-specific version of the mobile application for the financial institution may contain the user's identity specified as a long hash string. The user-specific version of the mobile application may also specify an authenticating scheme that the user specifies during the set up on the website. This authentication scheme may be used thereafter on the mobile application (e.g., a password or passphrase, but not the same as that used for online authentication). For example, the authentication scheme could be mobile friendly, e.g., it could consist of a 3×3 dot pattern, a pin code, a passphrase, a combination of these, or the like. The authentication scheme may be different from the user's online login, so if the user's mobile authentication is compromised, user's online account is still safe. In one example, because the user can only download a mobile application after authentication to the financial institution's website on a computer, the user can be sure that the mobile application is supplied by a trusted source.

In another example, a user may wish to restrict what may be accessed by a mobile application to make it child-safe, for example. In one particular example, a parent may want to limit their child to certain websites or certain content on a browser application. The parent may want a browser that disallows access to the full web. In accordance with techniques of this disclosure, the parent may visit a webpage associated, for example, with the browser application provider and specify a list of websites that the parent wants their child to be able to access. A version of the browser application may then be generated and provided to the user, where the generated version may only access the limited list of websites indicated by the user. In the generated version of the browser application, the checks may be hardcoded such that a user of the browser cannot break out of the list by altering the settings on the browser.

In another example, a parent wants to limit the telephone dialing application to a restricted set of telephone numbers. In accordance with techniques of this disclosure, the parent may visit a webpage associated with the mobile device, where the parent may specify a list of telephone numbers that a child or another user may be able to dial. As a result, the user may be provided with a mobile application that only works for those numbers, and may switch to this version of the dialing application when another user (e.g., a child) is using the parent's mobile device.

In yet another example, techniques of this disclosure may be implemented to provide protection against unauthorized distribution of applications. For example, in some situations when malicious users pay for a mobile application, they may copy the installer, and make the application available to others for no charge, or may even charge for it less than the source. Using techniques of this disclosure, user or device specific data may be encoded into the mobile application, and as a result, the application provider (e.g., service provider) may prevent unauthorized distribution several ways. In one example, during generation of the user-specific application, device international mobile equipment identity (IMEI) number may be encoded into the application, such that the application only works on the specific device associated with the user. In this example, even if the application is copied maliciously, it will refuse to work on an incorrect device, i.e., a device other than that belonging to the user. In another example, user's identity may be encoded in the application during generation, using a cryptographically strong hash. Once the identity is encoded, a pirated application may be tested against a list of users who have been sold the application and an offending user may be identified if the user does not match any user on the list.

As noted above, some of the advantage of the techniques of this disclosure may provide users of mobile computing devices the ability to customize mobile applications to their preferences. For example, using these techniques the need to log on applications that do not have sensitive information may be removed, while maintaining customization. Some example applications may be chatting applications, map applications, online store applications for browsing “store fronts.” In one example, the techniques of this disclosure may provide the ability to track down lost or stolen devices, based on user interaction with certain applications. For example, an application may periodically send a location associated with the computing device on which the application is running to an address associated with a server, e.g., via a web address or phone number. The address associated with the server to which the location information is sent may be requested during application set-up, and later hard-coded into the generated application. The location information may be acquired using a built-in location application, e.g., global positioning system (GPS). If the computing device that has the application is stolen or misplaced, the application may continue to send location information, which may assist in locating the stolen or lost computing device. Furthermore, corporations and companies may be able to utilize techniques of this disclosure to provide internal employee applications such as, for example, employee-specific versions of an application that provides access to human resources (HR) information.

Further examples that have been described throughout this disclosure may include financial institutions being able to provide trusted applications for mobile devices. In this manner, users may be more confident when using applications connected to more sensitive services and to their personal information. As another example, a user may customize certain mobile applications to reduce their complexities and increase safety for users who may not have sophisticated knowledge of using mobile computing devices, e.g., children. Furthermore, providers of mobile applications may be able to provide several levels of security and authentication based on the level of sensitivity of the data contained in the applications and/or the wishes of the user for whom the application is being generated.

The techniques described in this disclosure may be implemented, at least in part, in hardware, software, firmware, or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in a computer-readable medium, such as a computer-readable storage medium, containing instructions. Instructions embedded or encoded in a computer-readable medium, including a computer-readable storage medium, may cause one or more programmable processors, or other processors, to implement one or more of the techniques described herein, such as when instructions included or encoded in the computer-readable medium are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. In some examples, an article of manufacture may comprise one or more computer-readable storage media.

In some examples, computer-readable storage media may comprise non-transitory media. The term “non-transitory” may indicate that the storage medium is not embodied in a carrier wave or a propagated signal. In certain examples, a non-transitory storage medium may store data that can, over time, change (e.g., in RAM or cache).

Various embodiments of the disclosure have been described. These and other embodiments are within the scope of the following claims.

1. A method comprising:
receiving, by a web application executing on a first computing device, user information that specifies an authentication scheme and one or more preferences associated with a mobile application that is to be generated by the first computing device;
generating, by a compiler of the first computing device, a user-specific version of the mobile application based on the user information, the user-specific version of the mobile application providing the specified authentication scheme to authenticate access by a user to the user-specific version of the mobile application; and
communicating the generated user-specific version of the mobile application to a mobile computing device that is capable of executing the mobile application.

2. The method of claim 1, further comprising:
receiving, by the web application, authentication information from a user of the mobile computing device; and
requesting input from the user, wherein the input comprises the user information.

3. The method of claim 2, wherein the authentication information comprises a username and a corresponding password associated with the web application for the user.

4. The method of claim 1, wherein the user-specific version of the mobile application comprises at least a portion of functionality provided by the web application.

5. The method of claim 1, wherein generating the user-specific version of the mobile application comprises generating a representation of the user-specific version of the mobile application.

6. The method of claim 5, wherein the generated representation of the user-specific version of the mobile application comprises a uniform resource locator (URL), and wherein the mobile computing device launches the URL to obtain the user-specific version of the mobile application.

7. The method of claim 5, wherein the generated representation of the user-specific version of the mobile application comprises a computer-readable image, and wherein the mobile computing device scans the computer-readable image to obtain the user-specific version of the mobile application.

8. The method of claim 5, wherein the generated representation of the user-specific version of the mobile application comprises a short message service (SMS) message.

9. The method of claim 8, wherein the SMS message contains an executable code, and wherein the mobile computing device downloads the executable code to obtain a copy of the user-specific version of the mobile application.

10. The method of claim 1, wherein the first computing device comprises a server associated with the web application.

11. The method of claim 1, wherein the web application is associated with a financial service provider.

12. The method of claim 11, wherein the user information comprises information regarding financial accounts associated with a user of the mobile computing device and provided by the financial service provider.

13. The method of claim 1, wherein the web application is associated with a browser application, and wherein the user information comprises access limitations to a mobile version of the browser application running on the mobile computing device.

14. The method of claim 1, wherein the web application is associated with a dialing application of the mobile computing device, and wherein the user information comprises a list of telephone numbers that can be dialed using the mobile computing device.

15. The method of claim 1, wherein the user information comprises an identifier associated with the mobile computing device, the method further comprising encoding the generated user-specific version of the mobile application with the identifier associated with the mobile computing device.

16. The method of claim 15, wherein the identifier comprises an international mobile equipment identity (IMEI).

17. (canceled)

18. A computer-readable storage medium encoded with instructions that, when executed, cause one or more processors of a first computing device to perform operations comprising
receiving, by a web application executing on the first computing device, user information that specifies an authentication scheme and one or more preferences associated with a mobile application that is to be generated by the first computing device;
generating, by a compiler of the first computing device, a user-specific version of the mobile application based on the user information, the user-specific version of the mobile application providing the specified authentication scheme to authenticate access by a user to the user-specific version of the mobile application; and
communicating the generated user-specific version of the mobile application to a mobile computing device that is capable of executing the mobile application.

19. A first computing device, comprising:
one or more processors;
a module operable by the one or more processors to receive, by a web application executing on the first computing device, user information that specifies an authentication scheme and one or more preferences associated with a mobile application that is to be generated by the first computing device;
a module operable by the one or more processors to generate a user-specific version of the mobile application based on the user information, the user-specific version of the mobile application providing the specified authentication scheme to authenticate access by a user to the user-specific version of the mobile application; and
a module operable by the one or more processors to communicate the generated user-specific version of the mobile application to a mobile computing device that is capable of executing the mobile application.
